(19) United States
(12) Patent Application Publication
(10) Pub. No.: US 2018/0073153 A1
(43) Pub. Date: Mar. 15, 2018

(54) OPTICALLY TRANSPARENT OXYGEN GENERATION CATALYST, PRODUCTION METHOD THEREOF, AND CHEMICAL REACTOR UTILIZING THE SAME

(71) Applicant: KABUSHIKI KAISHA TOSHIBA, Minato-ku (JP)

(72) Inventors: Arisa YAMADA, Kawasaki (JP); Satoshi MIKOSHIBA, Yamato (JP); Akihiko ONO, Kita (JP); Yuki KUDO, Yokohama (JP); Jun TAMURA, Chuo (JP); Ryota KITAGAWA, Setagaya (JP); Eishi TSUTSUMI, Kawasaki (JP); Masakazu YAMAGIWA, Yokohama (JP); Yoshitsune SUGANO, Kawasaki (JP); Asahi MOTOSHIGE, Yokohama (JP)

(73) Assignee: KABUSHIKI KAISHA TOSHIBA, Minato-ku (JP)

(21) Appl. No.: 15/449,000

(22) Filed: Mar. 3, 2017

(30) Foreign Application Priority Data
Sep. 14, 2016 (JP) 2016-179716

(51) Int. Cl. C25B 11/04; C25B 1/00; C25B 1/04; C25D 9/04; B05D 1/00

(52) U.S. Cl. CPC C25B 11/0478; C25B 11/0405; C25B 11/0415; B05D 1/005; C25B 1/04; C25D 9/04; C25B 1/003

(57) ABSTRACT

The present embodiments provide: a catalyst having excellent optical transparency, catalytic activity and durability; and a method of producing the same. This catalyst comprises a graphene oxide layer and a nickel-iron layered double hydroxide layer supported on the surface of the graphene oxide layer. The graphene oxide layer has an average thickness of 0.33 to 4 nm. The catalyst can be produced by arranging graphene oxide on a substrate by a coating method and then allowing NiFe-LDH to be supported thereon.

### CROSS REFERENCE TO RELATED APPLICATIONS

This application is based upon and claims the benefit of priority from the prior Japanese Patent Application No. 2016-179716, filed on Sep. 14, 2016, the entire contents of which are incorporated herein by reference.

### FIELD

Embodiments of the present invention provide: an optically transparent oxygen generation catalyst; a production method thereof; and a chemical reactor utilizing the same.

### BACKGROUND

In recent years, due to the increase in the world population and energy utilization, the CO₂ emissions have been rapidly increasing, and reduction of CO₂ emissions and development of CO₂ fixation technology are pressing issues. Under such circumstances, artificial photosynthesis technology has been drawing attention recently.

This technology extracts oxygen and electrons through oxidation of water and reduces CO₂ with the electrons. There is an increasing number of studies on the oxidation reaction of water where NiFe layered double hydroxide (LDH) is used as a catalyst.

However, for utilization of this catalyst in the artificial synthesis technology, the catalyst is required to have high optical transparency and, therefore, a carrier material constituting the catalyst is also required to be highly transparent.

### BRIEF DESCRIPTION OF THE DRAWINGS

FIG. 1 is a schematic cross-sectional view of an oxygen generation catalyst according to the present embodiment; and

FIG. 2 is a schematic view of a chemical reactor according to the present embodiment.

### DETAILED DESCRIPTION

Embodiments will now be explained with reference to the accompanying drawings.

The oxygen generation catalyst according to the present embodiment comprises:

a graphene oxide layer; and

a nickel-iron layered double hydroxide layer supported on the surface of the graphene oxide layer,

wherein the graphene oxide layer has an average thickness of 0.33 to 4 nm.

The chemical reactor according to the present embodiment comprises:

an oxygen generation catalyst which comprises a graphene oxide layer and a nickel-iron layered double hydroxide layer supported on the surface of the graphene oxide layer, wherein the graphene oxide layer has an average thickness of 0.33 to 4 nm;

a reduction catalyst comprising a carbon dioxide reduction catalyst; and

a power supply element connected to the oxidation catalyst and the reduction catalyst.

The method of producing an oxygen generation catalyst according to the present embodiment comprises:

forming a graphene oxide layer by coating and then drying a graphene oxide-containing composition on a substrate surface; and

electrodepositing a nickel-iron layered double hydroxide on the surface of the graphene oxide layer using an aqueous solution containing iron ions and nickel ions.

### [Oxygen Generation Catalyst and Catalyst Complex]

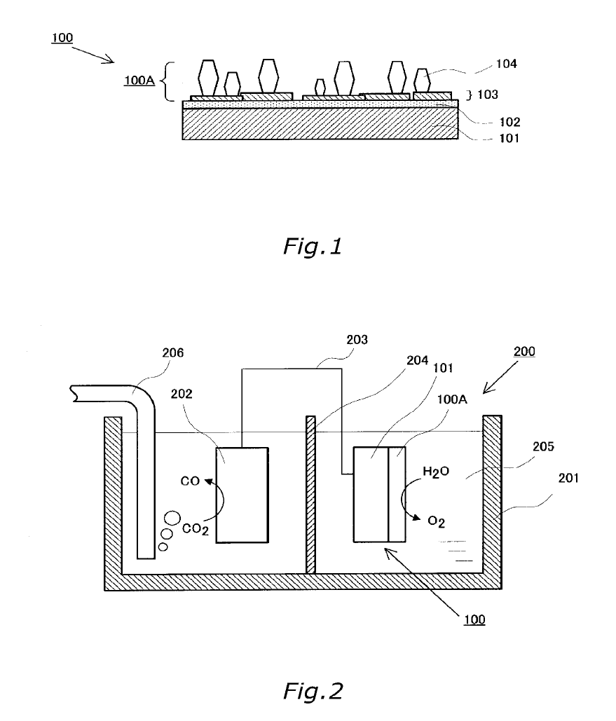

FIG. 1 is a schematic cross-sectional view of an oxygen generation catalyst 100 according to the present embodiment. A conductive layer 102 and a graphene oxide layer 103 are formed on the surface of a substrate 101, and nickel-iron layered double hydroxide 104 is arranged on the surface of the graphene oxide layer. It is noted here that the graphene oxide layer has a structure in which thin sections of graphene oxide having a two-dimensional structure are deposited in contact with the surface of the conductive layer.

It is indispensable that the oxygen generation catalyst according to the present embodiment contain, as a catalyst 100A, a combination of the graphene oxide layer and nickel-iron layered double hydroxide (hereinafter, may be referred to as “NiFe-LDH”) formed thereon. This catalyst is, however, preferably supported on a substrate from the standpoints of the ease of handling and the like. A combination of such a catalyst and a substrate is also included in the catalyst of the present embodiment and, for convenience, a combination of the oxygen generation catalyst 100A and the substrate 101 may be hereinafter referred to as “catalyst complex”.

### [Substrate]

The oxygen generation catalyst 100A according to the present embodiment exhibits a catalytic function by itself and is thus not necessarily required to be in the form of a catalyst complex comprising a substrate. However, from the standpoints of the ease of handling, the ease of production and the like, the catalyst complex is preferably supported on a substrate. As the substrate, a variety of materials and semiconductor elements may be used, and the substrate can be made of a material having a wider range of functions.

Since the catalyst according to the present embodiment is an electrochemical catalyst, it is desired that the substrate constituting the catalyst complex be a conductive substrate which contains a conductor or a semiconductor. Examples of the conductor include carbon materials such as carbon black, activated charcoal, fullerene, carbon nanotubes, graphene, Ketjen Black and diamond; transparent conductive oxides such as ITO, ZnO, FTO, AZO and ATO; metals such as Cu, Al, Ti, Ni, Ag, W, Co and Au; alloys containing at least one of these metals; and laminated films of these metals.

Examples of the semiconductor include Group IV semiconductors such as Si and Ge; Group III-V semiconductors such as GaAs, InP, GaN and GaP; and Group IV compound semiconductors such as SiC and SiGe. Further, semiconductors such as TiO₂, WO₃, BiVO₄, TaON and SrTiO₃ also have a photocatalytic function in combination and can thus be advantageously used as a material of a photochemical reaction cell.

In addition to substrates made of a single material, substrates having a device structure can also be used. For example, the substrate can be one which functions as a photovoltaic device by having a device structure comprising a semiconductor layer that separates charges with light energy. The use of such a substrate is preferred because it enables to bind the oxygen generation catalyst to a photovoltaic cell and light energy can consequently be utilized in an electrochemical reaction at a high efficiency.

### [Conductive Layer]

In cases where the catalyst according to the present embodiment comprises a substrate, it is preferred that the conductive layer 102 be formed between the substrate 101 and the graphene oxide layer 103 supported thereon. By providing the catalyst complex with the conductive layer, a high electroconductivity can be maintained between the substrate and the catalyst, so that the efficiency of the catalyst can be further improved.

As the material of the conductive layer, it is preferred to select a material which can improve the affinity or adhesion between the substrate and the graphene oxide layer. For example, when the graphene oxide layer is formed by a coating method as described later, it is preferred to use a material capable of forming a conductive layer that shows a more advantageous contact angle than that of the substrate surface.

Describing, as an example, a case where an amorphous silicon solar cell is adopted as the substrate and the graphene oxide layer is formed thereon, the contact angle of the substrate surface is 72°. By arranging a conductive layer having a smaller contact angle on the substrate surface, adhesion of the graphene oxide layer formed thereon can be improved. As such a material of the conductive layer, an inorganic material such as ITO (contact angle=about 61°), or a conductive polymer such as PEDOT:PEG (contact angle=about 53°), PEDOT:PSS or Nafion (registered trademark) can be used. The material of the conductive layer may be single component or the mixture of said materials. In order to optimize the adhesion to the substrate, conductivity, or transmission, it is preferred to combine two or more of said materials. Since the catalyst contributes to a photochemical reaction, it is preferred that the conductive layer be highly transparent. Specifically, at a wavelength of light that allows the photochemical reaction to proceed, the conductive layer has a light transmittance of preferably not less than 75%, more preferably not less than 90%.

The conductive layer may be constituted by a single layer or have a multilayer structure.

### [Graphene Oxide Layer]

The graphene oxide layer according to the present embodiment is a layer which directly supports NiFe-LDH.

As generally known, graphene oxide has a two-dimensional structure. In the present embodiment, as shown in FIG. 1, the graphene oxide layer has a structure in which thin sections of graphene oxide are deposited in contact with the surface of the conductive layer.

When a graphene oxide layer is formed by a commonly used electrodeposition method, the resulting graphene oxide layer is likely to have a structure in which the peripheries of the thin sections of graphene oxide and the surface of the conductive layer are in contact with each other. That is, the graphene oxide layer is likely to take a structure in which the thin sections of graphene oxide are standing on the surface of the conductive layer. Such a structure not only makes it difficult to increase the amount of NiFe-LDH adhering per unit area but also strengthens the electrical resistance between NiFe-LDH and the conductive layer, making it difficult to achieve sufficient catalyst efficiency. In addition, when the amount of graphene oxide adhering per unit area is increased in order to increase the amount of NiFe-LDH adhering per unit area, the resulting graphene oxide layer has a low light transmittance, and this is likely to result in a reduction in the efficiency of photochemical reaction and the cost performance. Moreover, in the formation of a graphene oxide layer by an electrodeposition method, it is also difficult to control the layer thickness and the like.

Meanwhile, the graphene oxide layer according to the present embodiment is a uniform layer having a relatively small thickness. Specifically, the graphene oxide layer according to the present embodiment has an average thickness of 0.33 to 8 nm, preferably 0.33 to 4 nm. Graphene oxide has a two-dimensional structure of a single carbon atom in thickness, and an average thickness of 0.33 to 4 nm thus means that the graphene oxide layer has a thickness equivalent to 1 to 12 carbon atoms. The average thickness of the graphene oxide layer can be measured using an AFM, an SEM, a TEM, an ellipsometer or the like.

In the catalyst according to the present embodiment, the graphene oxide layer has a uniform thickness. This is because the number of the graphene oxide thin sections adhering in a state of standing on the surface of the substrate is small. Accordingly, the graphene oxide layer characteristically has a narrow thickness distribution. Specifically, when the thickness is measured at a statistically sufficient number of spots on the catalyst surface, it is preferred that not less than 90% of all measured values be within a range of 0.33 to 4 nm. It is also preferred that the thickness variation over an area of 1-μm square, that is, the difference between the maximum thickness and the minimum thickness in an area of 1-μm square, be 2 nm or less. By allowing the graphene oxide layer to have a uniform thickness in this manner, the optical transparency of the graphene oxide is also made uniform, and this leads to an improvement in the overall efficiency of the catalyst. The thickness variation can be evaluated using an AFM, an SEM, a TEM, an ellipsometer or the like.

In the present embodiment, the graphene oxide layer can be produced by utilizing commercially available graphene oxide as is. Alternatively, graphene oxide prepared by oxidizing commercially available graphene may be used. The oxygen content of graphene oxide is not necessarily restricted; however, the oxygen content is preferably 3 to 50% by mole, more preferably 5 to 30% by mole.

Further, in order to make the coordination of NiFe-LDH easy, it is preferred to use nitrogen-containing graphene oxide. Nitrogen may be introduced by doping graphene oxide with nitrogen, or by chemically modifying graphene oxide with an amino group or the like. The nitrogen content of graphene oxide is not necessarily restricted; however, the nitrogen content is preferably 0.5 to 7% by mole, more preferably 1 to 5% by mole.

### [Nickel-Iron Layered Double Hydroxide]

The nickel-iron layered double hydroxide (NiFe-LDH) according to the present embodiment is specifically a non-stoichiometric compound represented by the following formula:

[Ni²⁺₁₋ₓFe³⁺ₓ(OH)₂][Aⁿ⁻_{x/n}·yH₂O]

(wherein,

x satisfies 0<X<1;

y represents the number of crystal water molecules; and

Aⁿ⁻ represents an anion constituting double hydroxide, such as a nitrate ion, a carbonate ion or a chloride ion).

The NiFe-LDH according to the present embodiment contains a nickel ion and a ferric ion as metal ions and may further contain other metal ion(s) such as a cobalt ion and an aluminum ion as long as the effects of the present embodiment are not impaired.

The NiFe layered double hydroxide constituting the NiFi-LDH layer according to the present embodiment has a layered structure in which molecular layers are laminated. Accordingly, particles of the NiFe layered double hydroxide are in the form of a plate or a thin section. In the present embodiment, the NiFe layered double hydroxide particles have an average particle size of 0.1 to 10 μm. The average particle size can be measured using an AFM, an SEM, a TEM, an ellipsometer or the like.

### [Method of Producing Oxygen Generation Catalyst]

The catalyst according to the present embodiment can be produced by an arbitrary method, for example, as follows.

First, a substrate is prepared. The substrate can be arbitrarily selected from the above-described ones in accordance with the intended use.

On this substrate, a conductive layer is formed as required. By forming a conductive layer, the thickness uniformity of the subsequently formed graphene oxide layer tends to be improved. When a conductive polymer is used as the material of the conductive layer, the conductive layer is formed by coating the surface of the substrate with a solution containing the polymer by a coating method, such as spin coating, dip coating, meniscus coating or spray coating and subsequently drying the substrate.

As the conductive polymer, it is preferred to use one which can yield a conductive layer having high optical transparency. As for the thickness of the conductive layer, the thinner the conductive layer, the more preferred it is from the standpoints of the cost and the optical transparency. Further, it is more preferred that the conductive layer show good adhesion with its underlying substrate and a graphene oxide layer to be formed thereon.

Alternatively, as the material of the conductive layer, an inorganic material such as ITO can also be used to form the conductive layer. When an inorganic material is used, the conductive layer can be formed by a CVD method or the like.

A graphene oxide layer is further formed on the substrate or the conductive layer formed on the surface of the substrate. In the present embodiment, the graphene oxide layer is characterized by being thin and uniform.

For the formation of such a graphene oxide layer, it is preferred to use a coating method such as spin coating or dip coating. By using a coating method, the thickness uniformity of the graphene oxide layer tends to be further improved.

Specifically, the graphene oxide layer is formed by dispersing graphene oxide in an aqueous solvent containing a polar solvent such as water or an alcohol, coating the surface of the substrate with the resulting dispersion and subsequently drying the substrate. In this process, the concentration of the dispersion and the coating conditions are adjusted such that the resulting graphene oxide layer has an appropriate thickness.

In the present embodiment, it is preferred that the graphene oxide layer contain nitrogen. In order to introduce nitrogen into the graphene oxide layer, for example, after the formation of the graphene oxide layer, its surface is treated with a nitrogen-containing compound such as ammonia or an amine compound. By bringing an aqueous solution containing such a compound or the like into contact with the graphene oxide layer, amino groups or the like can be introduced into graphene oxide layer. Alternatively, the graphene oxide layer can be doped with nitrogen by an ion implantation method or the like.

Further, the graphene oxide layer can also be formed after allowing a nitrogen-containing compound to react with graphene oxide.

As required, the graphene oxide layer can be subjected to an UV treatment for introduction of carbonyl groups and an ozone treatment for introduction of carboxyl groups. In addition, as required, the graphene oxide layer can also be subjected to a hydrazine treatment so as to reduce some of the graphene oxide molecules into graphene and to thereby reduce the number of hydroxyl groups, carboxyl groups, epoxy groups and the like. For each of these treatments, an optimum one can be selected taking into consideration, for example, the adhesion with the conductive layer and the adhesion with NiFe-LDH.

The carboxyl groups and amino groups introduced by these treatments make the Fe and Ni ions constituting NiFe-LDH more likely to be coordinated. Particularly, iron has good compatibility with an amino group and is thus preferred.

NiFe-LDH is formed on the surface of the thus formed graphene oxide layer. It is preferred that NiFe-LDH be formed by an electrodeposition method. Such a method of forming NiFe-LDH can be selected from generally known methods. Specifically, the substrate on which the graphene oxide layer has been formed is immersed in an aqueous solution containing Ni ions and Fe ions and a voltage is applied thereto, whereby NiFe-LDH is formed on the surface of the graphene oxide layer. Alternatively, NiFe-LDH can be formed by depositing Ni and Fe on the surface of the graphene oxide layer by spattering, ion plasma, or atomic layer deposition, and following treatment such as oxidation in the aqueous solution.

In this electrodeposition, when amino groups and carboxyl groups have been introduced to the graphene oxide layer as described above, reaction nuclei are formed using these substituents as their origins, and electrodeposition is thus likely to occur. When the pH is acidic during the electrodeposition, the amino groups function in coordination more preferentially than the carboxyl groups.

According to the present embodiment, good adhesion is attained between the catalyst and the surface of the substrate. In addition, graphene oxide uniformly and sufficiently adheres to the surface of the substrate; therefore, the amount of graphene oxide and LDH adhering per unit area can be increased, and this enables to provide a catalyst having excellent optical transparency, catalytic activity and durability, so that a highly efficient and highly durable electrochemical or photoelectrochemical device can be realized.

### [Photochemical Reactor]

FIG. 2 is a schematic drawing that shows one example of a chemical reactor comprising the catalyst according to the present embodiment.

A chemical reactor 200 comprises an electrolyzer 201, which is filled with an electrolyte solution 205. The electrolyzer may have a cylindrical shape or a rectangular column shape. The electrolyzer 201 is divided into two sections by an ion exchange membrane 204. This ion exchange membrane allows only specific ions to pass therethrough and, at the same time, separates a product generated in a first catalyst layer from a product generated in a second catalyst layer.

The catalyst complex 100 according to the present embodiment is immersed in an electrolyte solution of one of the two sections while an electrode 202 serving as a counter electrode is immersed in an electrolyte solution of the other section, and these electrodes are electrically connected via a conductive wire 203.

In FIG. 2, the electrode 202 can comprise a reduction catalyst such as Au nanoparticles. In FIG. 2, carbon dioxide to be reduced by the electrode 202 comprising the reduction catalyst is introduced into the electrolyte solution via a carbon dioxide introduction pipe 206.

Further, in FIG. 2, the substrate 101 is a semiconductor which separates charges with light energy, such as a solar cell. This semiconductor functions as a power supply element in this reactor.

On a first principal surface of the substrate 101, which is the light incident surface, the oxygen generation catalyst 100A according to the present embodiment is arranged. Meanwhile, on a second principal surface on the other side, an electrode layer (not shown) can be formed.

In this photochemical reactor, when light is irradiated to the substrate 101 (solar cell) through the catalyst 100A, an electromotive force generated in the substrate induces redox reactions of molecules or ions contained in the electrolyte solution by the catalyst 100A and the reduction catalyst arranged on the electrode 202.

Therefore, the solar cell is required to have an open-circuit voltage of not less than the difference between the standard redox potential of the oxidation reaction taking place on the oxygen generation catalyst and the standard redox potential of the reduction reaction taking place on the reduction catalyst. For example, in cases where holes and electrons generated in the substrate 101 migrate to the first and second principal surfaces of the catalyst complex 100, respectively, and an oxidation reaction of water and a reduction reaction of CO₂ into CO take place on the catalyst 100A and the reduction catalyst, respectively, these chemical reactions can be represented by the following reaction formulae (1) and (2):

Oxidation side: 2H₂O+4h⁺→4H⁺+O₂ (1)

Reduction side: 2CO₂+4H⁺→2CO+2H₂O (2)

These reactions of the formulae (1) and (2) have a standard redox potential of 1.23 V/vs.NHE and −0.1 V/vs.NHE, respectively. Accordingly, the open-circuit voltage of the semiconductor layer is required to be not less than 1.33 V. More preferably, the semiconductor layer is desired to have an open-circuit voltage equivalent to the potential difference including an overvoltage. For example, assuming that the overvoltage is 0.2 V in each of the reactions of the formulae (1) and (2), the open-circuit voltage is preferably not less than 1.73 V.

As the semiconductor layer (solar cell) used in the photochemical reactor, since it is required to absorb light and separate charges, a pn junction-type or pin junction-type semiconductor layer is desirable. Examples of a material that can be used as a semiconductor include silicon, germanium and silicon-germanium, and examples of a compound semiconductor system include GaAs, GaInP, AlGaInP, CdTe and CuInGaSe systems. These materials can be applied in a single-crystal, polycrystalline or amorphous form. Further, in order to obtain a large open-circuit voltage, the semiconductor layer is more preferably a multi-junction type photoelectric conversion layer.

A transparent conductive layer (not shown) may be arranged between the oxygen generation catalyst 100A and the substrate 101 which is a semiconductor.

The semiconductor layer does not have to be constituted by a pn junction-type or pin junction type semiconductor, and it may be constituted by a p-type or n-type semiconductor. In this case, a barrier formed at the electrolyte solution-semiconductor interface by light irradiation can be utilized to drive the redox reactions. In cases where such an open-circuit voltage that drives the redox reactions cannot be obtained, an auxiliary power supply may also be arranged in the section of the conductive wire so as to supplement the voltage shortage.

### [Other Chemical Reactors]

The catalyst or catalyst complex according to the present embodiment can be used as a catalyst of an existing chemical reactor such as a battery or an electrolysis cell, particularly a CO₂ reduction reactor. Examples of the electrolysis cell include water electrolysis cells and CO₂ electrolysis cells. These electrolysis cells may have a simple cell structure in which an anode and an cathode that are immersed in an electrolyzer are separated by a diaphragm as in an alkaline water electrolysis cell, or an MEA (Membrane Electrode Assembly) structure in which an anode, a solid polymer membrane and a cathode are laminated as in a solid polymer electrolysis cell. These electrolysis cells are driven by, for example, a system power supply or an external power supply of renewable energy such as solar energy, wind power or geothermal energy. Particularly, a reactor utilizing sunlight is different from the above-described photochemical reactor in that a semiconductor layer is arranged outside of an electrolysis cell.

As the electrolyte solution in the above-described photochemical reactor and electrochemical cells, an arbitrary electrolyte solution can be used in accordance with the intended purpose. For example, as an electrolyte solution with which an electrode that generates oxygen using the catalyst according to the present embodiment comes into contact, an aqueous solution containing H₂O subjected to the reaction can be used. As this electrolyte solution, it is preferred to use an aqueous solution containing an arbitrary electrolyte(s). Examples of such an aqueous solution include aqueous solutions containing phosphate ions (PO₄²⁻), borate ions (BO₃³⁻), sodium ions (Na⁺), potassium ions (K⁺), calcium ions (Ca²⁺), lithium ions (Li⁺), cesium ions (Cs⁺), magnesium ions (Mg²⁺), chloride ions (Cl⁻), bicarbonate ions (HCO₃−) and/or the like.

Further, as the electrolyte solution with which a counter electrode comes into contact, a solution containing CO₂ subjected to the reduction reaction can be used. This CO₂-containing solution is preferably a solution having a high CO₂ absorptivity, and examples thereof include aqueous solutions of LiHCO₃, NaHCO₃, KHCO₃, CsHCO₃ and the like.

The CO₂-containing solution may contain an alcohol such as methanol, ethanol or acetone as a solvent. The H₂O-containing solution may be the same as the CO₂-containing solution. Since the CO₂-containing solution is preferred to have a large amount of absorbed CO₂, the CO₂-containing solution may be different from the aqueous solution with which an electrode that generates oxygen is in contact. The CO₂-containing solution is desirably an electrolyte solution which lowers the reduction potential of CO₂, has a high ionic conductivity and contains a CO₂ absorbent.

Specific examples of an electrolyte solution other than the above-described ones include ionic liquids, which contain a salt of a cation such as an imidazolium ion or a pyridinium ion and an anion such as BF₄⁻ or PF₆⁻ and are in a liquid state over a wide temperature range, and aqueous solutions thereof.

Examples of the cation in the ionic liquids include a 1-ethyl-3-methylimidazolium ion, a 1-methyl-3-propylimidazolium ion, a 1-butyl-3-methylimidazole ion, a 1-methyl-3-pentylimidazolium ion and a 1-hexyl-3-methylimidazolium ion. Imidazolium ions substituted at the 2-position, such as 1-ethyl-2,3-dimethylimidazolium ion, a 1,2-dimethyl-3-propylimidazolium ion, a 1-butyl-2,3-dimethylimidazolium ion, 1,2-dimethyl-3-pentylimidazolium ion and a 1-hexyl-2,3-dimethylimidazolium ion, can also be used. Examples of the pyridinium ion include methylpyridinium, ethylpyridinium, propylpyridinium, butylpyridinium, pentylpyridinium and hexylpyridinium ions. These imidazolium ions and pyridinium ions may be substituted at a hydrocarbon group and may contain an unsaturated bond. Examples of the anion include a fluoride ion, a chloride ion, a bromide ion, an iodide ion, BF₄⁻, PF₆⁻, CF₃COO⁻, CF₃SO₃⁻, NO₃⁻, SCN⁻, (CF₃SO₂)₃C⁻, a bis(trifluoromethoxysulfonyl)imide anion and a bis(perfluoroethylsulfonyl)imide anion. A dipolar ion in which a cation and an anion of an ionic liquid are bound via a hydrocarbon chain may also be used.

Examples of an electrolyte solution also include amine solutions of ethanolamine, imidazole, pyridine or the like, and aqueous solutions thereof. The amine may be any one of primary amines, secondary amines and tertiary amines. The hydrocarbon groups contained in these amines may be substituted with a hydroxyl group, a halogen or the like and may also contain an unsaturated bond. Further, in the secondary and tertiary amines, the hydrocarbons contained in each amine may be the same or different.

Examples of such primary amines include methylamine, ethylamine, propylamine, butylamine, pentylamine and hexylamine. Examples of the secondary amines include dimethylamine, diethylamine, dipropylamine, dibutylamine, dipentylamine, dihexylamine, dimethanolamine, diethanolamine, dipropanolamine, methylethylamine and methylpropylamine. Examples of the tertiary amines include trimethylamine, triethylamine, tripropylamine, tributylamine, trihexylamine, trimethanolamine, triethanolamine, tripropanolamine, tributanolamine, trihexanolamine, methyldiethylamine and methyldipropylamine.

### EXAMPLES

### Example 1-1

In this Example, 0.02-wt % PEDOT:PEG was spin-coated on an ITO substrate which had been washed with water and acetone. Further, 0.5 mg/L of graphene oxide was spin-coated thereon to form a graphene oxide layer. The spin coating was performed under the following conditions: at 500 rpm for 3 seconds, 3-second sloping, and then at 1,500 rpm for 60 seconds.

The surface of the thus formed graphene oxide layer was treated with ammonia.

On this graphene oxide layer, a NiFe-LDH layer was electrodeposited as an oxygen generation catalyst under the following conditions.

A solution in which equal amounts of an 80-mM aqueous Ni(NO₃)₂.6H₂O solution and a 20-mM aqueous Fe(NO₃)₃.9H₂O solution were mixed was prepared as an electrolyte solution. The electrodeposition on the graphene oxide layer was performed using this electrolyte solution. Using Kapton tape, only a prescribed area (8 mmφ) of the graphene oxide layer surface of a sample was exposed. The sample was arranged as a working electrode in one chamber of an H-type cell, a Pt wire was arranged as a counter electrode in the other chamber, and a glass filter was installed between these two chambers. Further, an Ag/AgCl electrode was arranged as a reference electrode. Using this apparatus, electrodeposition was performed at a voltage of −1.2 V (vs NHE) for 10 seconds to prepare a catalyst. In the thus obtained catalyst, the thickness of the graphene oxide layer was in a range of 2 to 4 nm and the thickness variation in an area of 1-μm square was 2 nm or less.

### Comparative Example 1-1

A catalyst was prepared and evaluated under the same conditions as in Example 1, except that the graphene oxide layer was arranged.

### Example 1-2

A catalyst was prepared and evaluated under the same conditions as in Example 1-1, except that PEDOT:PSS was used in place of PEDOT: PEG.

### Example 1-3

A catalyst was prepared and evaluated under the same conditions as in Example 1-1, except that Nafion was used in place of PEDOT: PEG.

### Example 1-4

A catalyst was prepared and evaluated under the same conditions as in Example 1-1, except that a layer of PEDOT:PEG was not arranged.

### Example 1-5

A catalyst was prepared and evaluated under the same conditions as in Example 1-1, except that the electrolyte solution used for the electrodeposition of NiFe-LDH was changed to a mixture of equal amounts of a 20-mM aqueous Ni(NO₃)₂.6H₂O solution and a 5-mM aqueous Fe(NO₃)₃.9H₂O solution.

### Comparative Example 1-2

A catalyst was prepared under the same conditions as in Example 1-1, except that the graphene oxide layer was formed by electrodeposition. The electrodeposition of the graphene oxide layer was performed under the following conditions. An electrolyte solution was prepared by adding LiClO₄ to a 1.6 g/L dispersion of graphene at a concentration of 0.1 M. Next, a sample was arranged as a working electrode in one chamber of an H-type cell, a Pt wire was arranged as a counter electrode in the other chamber, and a glass filter was installed between these two chambers. Further, an Ag/AgCl electrode was arranged as a reference electrode. This H-type cell was filled with the thus obtained electrolyte solution, and electrodeposition was performed at a voltage of −1.0 V (vs NHE) for 10 seconds to form a graphene oxide layer. Thereafter, a catalyst was prepared in the same manner as in Example 1-1.

In Example 1-1, an oxidation current of about 13 mA/cm² was observed at 1.9 V (vs NHE). In addition, the catalyst attained a transmittance of 90% or higher over the entire wavelength range of visible light, showing a transparency of 95% or higher as a whole. Meanwhile, in Comparative Example 1-2, the oxidation current was measured to be 0.5 mA/cm² and the transmittance was 85%. In addition, the transparency was largely variable depending on the spot and the uniformity was thus poor. A transparency of 70% was found at some spots, while other spots had a transparency of 90%. Furthermore, when the thickness of the graphene surface was observed, thick spots and thin spots were found and, although the thickness was substantially uniform in a very small area (0.2-μm square or smaller), a thickness difference of not smaller than 2 nm to about 4 nm at the largest was observed over an area of 1-μm square. In contrast, such a thickness difference was not confirmed in any of Examples, and hardly any thickness variation was observed.

In Comparative Example 1-1, an oxidation current of about 1 mA/cm² was observed, so that the catalyst was found to have a low activity. In Comparative Example 1-1, a tendency of the transparency to be reduced by reaction was confirmed; however, such a tendency was not observed in Example 1-5. In Example 1-4, the oxidation current was 11 mA/cm² at 1.9 V (vs NHE) and a slight reduction in performance was observed.

Furthermore, in Examples 1-2 and 1-3, the oxidation current was 10.6 mA/cm² at 1.9 V (vs NHE), so that these catalysts were found to have a slightly lower performance than the catalyst of Example 1-1. Therefore, it was found preferable to use PEDOT: PEG as the material of the conductive layer. This is speculated to be attributed to that, when PEDOT:PSS and Nafion are used, since the oxidation reaction of water requires OH⁻, the sulfonate groups in the structure of these materials work disadvantageously.

The catalyst properties were measured based on stationary polarization where the potential is changed for every 30 or 50 mV and the current value is read out at each potential after 5 minutes. In addition, the series resistance components R such as solution resistance and substrate resistance were determined by alternating current impedance measurement, and the effective potential applied to the subject electrode (Eₐₚₚₗ−IR) was calculated. Further, the overvoltage η of the oxygen generation reaction was estimated using the following equation.

$$\begin{matrix}η = ( {E}_{appl} - IR ) - {E}_{0} + {E}_{ref} \\ = ( {E}_{appl} - IR ) - 1.23 + 0.059 \times pH + 0.199\end{matrix} \qquad ( 1 )$$

### (Example 2-1) Photochemical Reactor

In this Example, a photochemical reactor comprising the catalyst according to the present embodiment was evaluated.

First, a triple-junction solar cell composed of a pin-type amorphous silicon (a-Si) layer and two pin-type amorphous silicon-germanium (a-SiGe) layers was prepared. This solar cell had an open-circuit voltage of 2.1 V. The light-receiving surface of this solar cell was on the p-side where an ITO electrode was formed. On the n-side surface of the solar cell, a ZnO electrode, an Ag reflective layer and a stainless steel substrate as a support substrate were arranged.

Then, on the surface of the ITO membrane, a conductive polymer layer, a graphene oxide layer and a NiFe-LDH layer were formed as an oxygen generation catalyst in the same manner as in Example 1-1. The graphene oxide layer was treated with ammonia as in Example 1-1.

### Example 2-2

An UV treatment was performed in place of the ammonia treatment in Example 2-1.

### Example 2-3

An ozone treatment was performed in place of the ammonia treatment in Example 2-1.

### Example 2-4

A hydrazine treatment was performed in place of the ammonia treatment in Example 2-1.

The stainless steel surface of each of the thus prepared samples was electrically connected with a conductive wire using a copper tape. Further, the conductive wire was passed through a glass tube (diameter=6 mm), and the gap between the sample and the glass tube was sealed with an epoxy resin. Then, the peripheries of the sample surface and the entire back side of the sample were sealed with an epoxy resin to prepare an electrode.

Each photoelectrochemical device was evaluated by using an electrode containing each sample (area=1 cm²) as a working electrode and a Pt wire as a counter electrode and irradiating light to the catalyst layer side of the subject electrode in a potassium bicarbonate electrolyte solution (0.5 M) using a solar simulator (Am 1.5, 1,000 W/m²). Under light irradiation, the current flowing between the working electrode and the counter electrode was measured with no bias being applied between the electrodes. The thus measured current value corresponds to the amount of the reaction generating oxygen and hydrogen from water.

In Example 2-1, a current of 4.7 mA/cm² was stably produced by the light irradiation. The current was measured to be 4.5 mA/cm², 3.8 mA/cm² and 3.2 mA/cm² in Examples 2-2, 2-3 and 2-4, respectively.

It is believed that these results were obtained because a carboxyl group and an amino group are easily coordinated with Fe and Ni ions and particularly, the affinity between an Fe ion and an amino group is high. When the number of functional groups on graphene was reduced by a hydrazine reduction treatment, the current density was relatively low.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the invention.

1. An oxygen generation catalyst comprising:
a graphene oxide layer; and
a nickel-iron layered double hydroxide layer supported on the surface of said graphene oxide layer,
wherein said graphene oxide layer has an average thickness of 0.33 to 4 nm.

2. The catalyst according to claim 1, wherein said graphene oxide layer contains nitrogen.

3. The catalyst according to claim 1, wherein said graphene oxide layer has a thickness variation of 2 nm or less in an area of 1-μm square.

4. The catalyst according to claim 1, further comprises a substrate to support said graphene oxide layer.

5. The catalyst according to claim 4, further comprising a conductive layer between said substrate and said graphene oxide layer.

6. The catalyst according to claim 5, wherein said conductive layer contains a conductive polymer.

7. The catalyst according to claim 4, wherein said substrate is a conductive substrate.

8. The catalyst according to claim 4, wherein said substrate comprises a semiconductor layer which performs charge separation with light energy.

9. A chemical reactor comprising:
an oxygen generation catalyst which comprises a graphene oxide layer and a nickel-iron layered double hydroxide layer supported on the surface of said graphene oxide layer, wherein said graphene oxide layer has an average thickness of 0.33 to 4 nm;
a reduction catalyst comprising a carbon dioxide reduction catalyst; and
a power supply element connected to said oxygen generation catalyst and said reduction catalyst.

10. The chemical reactor according to claim 9, wherein said power supply element comprises a semiconductor layer which performs charge separation with light energy.

11. The chemical reactor according to claim 10, wherein said oxygen generation catalyst is formed on said semiconductor layer which performs charge separation with light energy.

12. A method of producing an oxygen generation catalyst, said method comprising:
forming a graphene oxide layer by coating and then drying a graphene oxide-containing composition on a substrate surface; and
electrodepositing a nickel-iron layered double hydroxide on the surface of said graphene oxide layer using an aqueous solution containing iron ions and nickel ions.

13. The method according to claim 12, wherein said graphene oxide-containing composition is coated by spin-coating.
